(19) United States
(12) Patent Application Publication
(10) Pub. No.: US 2008/0156718 A1
(43) Pub. Date: Jul. 3, 2008

(54) Spacer for Membrane Modules, a Membrane Module and Uses Thereof

(76) Inventor: Knud Verner Larsen, Maribo (DK)

Correspondence Address: MICHAUD-DUFFY GROUP LLP, 306 INDUSTRIAL PARK ROAD, SUITE 206, MIDDLETOWN, CT, 06457, US

(21) Appl. No.: 11/884,044

(22) PCT Filed: Feb. 24, 2006
(86) PCT No.: PCT/SE06/00258

§ 371 Date: Feb. 7, 2008

(30) Foreign Application Priority Data
Feb. 28, 2005 (SE) 0500469-2

(51) Int. Cl. B01D 63/00

(52) U.S. Cl. 210/321.75; 210/487; 428/72; 210/486; 210/321.83; 210/321.85; 210/321.74; 210/321.84

(57) ABSTRACT

The present invention relates to a spacer for membrane modules comprising at least one inserted element and support members, the support members being spaced apart by the at least one inserted element forming flow channels between the support members and the inserted element for guiding permeates to the at least one permeate collection device, which at least one permeate collection device being in perpendicular contact with the flow channels, or guiding concentrate through flow channel out of the membrane module. The invention relates further to a membrane module comprising the permeate spacer, uses of the membrane module and a spiral wound membrane comprising the permeate spacer.

The present invention relates to a spacer, a membrane module, and use of the membrane module.

### BACKGROUND OF INVENTION

The fluids passing through a membrane have to be transported to the membrane or be in contact with the membrane before passing the membrane. After passage the fluids are collected in a draining system and transported out of the system. Many membranes utilise spacers for transportations of fluids to and from the membranes. EP 11201150, WO 2004/103535 and WO 2004/103536 disclose membrane spacers.

The draining system, which is collecting the fluids, can be an obstruction for the fluids, and thereby generating a counter pressure resulting in creating a pressure drop. The counter pressure may limit the flux through the membrane and the pressure drop may cause fouling of the membrane and limit its performance.

Thus, one object of the present invention is to improve the design of the draining system and thus increase the performance of the membrane.

Another further object is to provide membranes having improved energy balance.

### THE INVENTION

Membranes can be used for microfiltration, ultrafiltration, nanofiltration or reverse osmosis. Microfiltration is the coarsest of the membrane filtration classes typically in the range of 0.1 to 10 micrometer (μm). Ultrafiltration membranes are classified by the molecular weight cut off which is defined as the molecular weight of the smallest molecule, 90% of which is retained by the membrane. Ultrafiltration range spans from 1000 to 500,000 molecular weight cut off. Nanofiltration membranes retain solute molecules having a molecular weight ranging from 100 to 1,000. Reverse osmosis involves the tightest membranes, which are capable of separating even the smallest solute molecules.

The fluids, which have passed a membrane or a membrane-film, are defined as permeate. The fluids, which are left, are defined as concentrate or retentate hereinafter defined as concentrate. Membranes can be spaced apart by inserted elements, spacers or spacer elements, which are divided into two groups, permeate spacers and concentrate spacers. The created space between the membranes will constitute flow space for permeates or the concentrates.

Spacers or inserted elements can be manufactured of corrugated material, of pleated material, casted material, extruded material, or machined material providing a structure, which allows the fluids free flow to a collecting system or collecting device.

Hereinafter spacer defines the member spacing apart membranes or membrane films. Inserted element defines the element spacing apart support members.

The invention relates to a spacer for membrane modules comprising at least one inserted element and support members selected from at least one member of the group consisting of support surface units, solid surface material(s) having perforations, porous surface material(s), composite surface material(s) having perforations or pores or combinations thereof, sandwich surface material(s) having perforations or pores, or combinations thereof, the support members being spaced apart by the at least one inserted element forming flow channels between the support members and the inserted element for guiding permeates to the at least one permeate collection device, which at least one permeate collection device being in perpendicular contact with the flow channels, or guiding concentrate through flow channel out of the membrane module.

The shape of pores or of perforations, the frequency of them or the amount can be adjusted depending of the pressure range, viscosity or temperature of the fluids. The perforations can be holes, slots, slits, or combinations thereof.

Inserted elements can be longitudinal walls, corrugated sheet, pleated sheet, casted sheet, moulded sheet, extruded sheet, sheet having ducts, sheet having cut or flat peaks, single distance aids, or combinations thereof.

The flow space between the support members and the inserted elements is forming passages or flow channels. The passages can be connected perpendicular to a permeate collection device. The passages can be extending along each other according to one alternative embodiment. According to yet another embodiment are the inserted element forming passages extending parallel along each other. The permeate collection device can be a permeate central collection tube, or a permeate tube. According to one alternative embodiment the permeate collection tube can be a permeate tube disclosed in SE 0402542-5 and in SE 0403169-6 (both SE-applications being priority documents for PCT/SE2005/001554).

The permeate spacer can have a thickness of at least 0.1 mm, the thickness can be as large as less than or equal to about 20 mm. According to one alternative embodiment can the thickness be at least 0.2 mm, and yet another alternative embodiment the thickness can be at least 0.5 mm. According to yet another alternative embodiment the thickness can be within the range of from about 0.1 mm to about 20 mm. According to yet another alternative embodiment the thickness can be within the range of from about 0.5 mm to about 15 mm. According to yet another alternative embodiment the thickness can be within the range of from about 1 mm to about 5 mm. According to yet another alternative embodiment the thickness can be within the range of from about 0.1 mm to about 2.0 mm. According to yet another alternative embodiment the thickness can be within the range of from about 0.5 mm to about 1.5 mm.

The support members and inserted elements can be manufactured of the same material, or the support material can be manufactured of one material and the inserted elements of another material. The material can be metal, plastic, composite, paper, porous material, polymeric, or combinations thereof. According to one alternative embodiment the material can be selected from at least one of the materials of the group consisting of polyolefin elastomers, ethylene vinyl acetate copolymers, ethylene vinyl acetate terpolymers, styrene-ethylene/butylenes-styrene block copolymers, polyurethanes, polybuthylene, polybuthylene copolymers, polyisoprene, polyisopren copolymers, acrylate, silicones, natural rubber, polyisobutylene, butylrubber, polypropylene, polypropylene copolymers, polyethylene, polyethylene copolymers, polycarbonate, fluoropolymers, polystyrene, acrylonitrile-butadien-styrene copolymers, nylons, polyvinylchloride, and copolymers and blends thereof.

An extruded sheet in polyethylene, polypropylene or PET with longitudinal grooves draining the membrane in pre-determined flow direction from specific areas without the mixing effect based on different transmembrane pressures leading to negative flux causing membrane delamination and ruptures. The spacer will used in the other direction and made in the appropriate thickness form a concentrate spacer with a fully open and well defined channel less prone to blockage due to liquids with fibres ect.

The invention relates further to membrane module wherein the at least one spacer being at least one permeate spacer and at least one concentrate spacer, and membrane films being attached on both sides of the at least one permeate spacer.

A membrane module may also comprises one or more permeate transfer leaves, and one or more membrane leaves, which one or more permeate transfer leaves, and one or more membrane leaves together with the at least one permeate spacer, the at least one concentrate spacer, being wound around the permeate collection device, which permeate collection device being a permeate collection tube, which permeate collection tube comprises at least one tubular unit, which unit has spaced substantially along the unit's length a plurality of permeate transfer means, and one or more external grooves forming flow channels connecting the permeate transfer means, and at least a part of the inner side of each tubular unit having polygonal cross-section.

According to another alternative embodiment the membrane module comprise membranes attached on both sides of a permeate spacer and a concentrate spacer comprising at least two support members spaced apart by at least one inserted element and forming free flow channels between the support members and the inserted elements, wherein the support members are provided with pores or perforations extending from the free flow channels. The membrane module can be a spiral wound membrane. The spiral wound membrane can have at least one permeate tube disclosed in PCT/SE2005/001554 according to one alternative embodiment.

In membrane modules or spiral wound membranes the spacer can be used to collect permeates without generating a counter pressure. In a spiral wound membrane the permeate spacer can be wounded in such a way that the permeate spacer is forming channels or passages going spirally into the centre of the spiral wound membrane to meet the permeate collection tube. According to one alternative embodiment the membrane system can be used together with a concentrate spacer having passages. Both the permeate spacer and the concentrate spacer are wounded around a permeate collection tube to form a spiral wound membrane according to one alternative embodiment.

Due to the low-pressure drop in the membrane module or in the spiral wound membrane it is possible to treat water with nanofiltration membranes for the removal of divalent ions like calcium, magnesium etc., or low organic molecules like pesticides just by using the hydrostatic pressure.

The invention relates to use of a membrane module comprising a permeate spacer according to the invention for treatment of wastewater, seawater, surface water or well water.

The membrane module can be used as a pre-treatment of water, such as for example seawater, surface water or well water, before a desalination plant of the reverse osmosis type. The membrane module can also be used in preparation of drinking water from surface water or well water. The membrane module can be used as a pre-treatment or as a final treatment of water.

The membrane module according to the present invention can be used for microfiltration, ultrafiltration, nanofiltration, or reverse osmosis. According to one alternative embodiment the membrane module can be used for applications such as desalination. According to another alternative embodiment the membrane module can be used for treating proteins, and protein products. According to another alternative embodiment the membrane module can be used for treating milk and milk products. According to another further alternative embodiment the membrane module can be used for treating polysaccharides and polysaccharide products. According to another further alternative embodiment the membrane module can be used for treating starches and starch products. According to another further alternative embodiment the membrane module can be used for treating oils, vegetable oils and oil products.

Due to the low-pressure drop in the membrane module it is possible to treat water with nanofiltration membranes for the removal of divalent ions like calcium, magnesium etc., or low organic molecules like pesticides. The spiral wound membrane can also be used for sterile filtration, clarification, or concentration of high molecule weights. The membrane module can be used for processing of vine, beer, fruit juice concentration, sterile filtration of milk.

According to one alternative embodiment can the membrane module be a spiral wound membrane to be used in any of the above-described use alternatives.

Further developments are specified in independent claims and the dependent claims.

The invention is intended to be explained in more detail in the following by means of the attached drawings.

### BRIEF DESCRIPTION OF THE DRAWINGS

FIG. 1 is showing a schematic part view of one alternative embodiment of the spacer.

FIG. 2 is showing a part of overview of a produced extrude sheet having flow channels and support units according to one alternative of the invention.

FIG. 3 is showing a cross view of a part of an extruded sheet according to one alternative embodiment of the spacer.

FIG. 4 is showing a cross view of a part of an extruded sheet according to another alternative embodiment of the spacer.

FIG. 5 is showing a cross view of a part of an extruded sheet according to another alternative embodiment of the spacer.

FIG. 6 is showing a cross view of a part of pleated sheet spacer according to one alternative embodiment of the spacer.

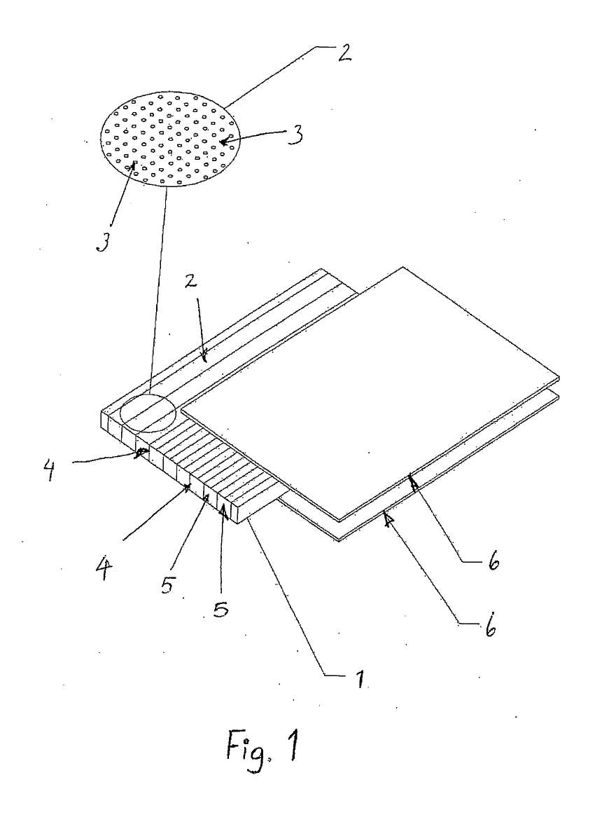

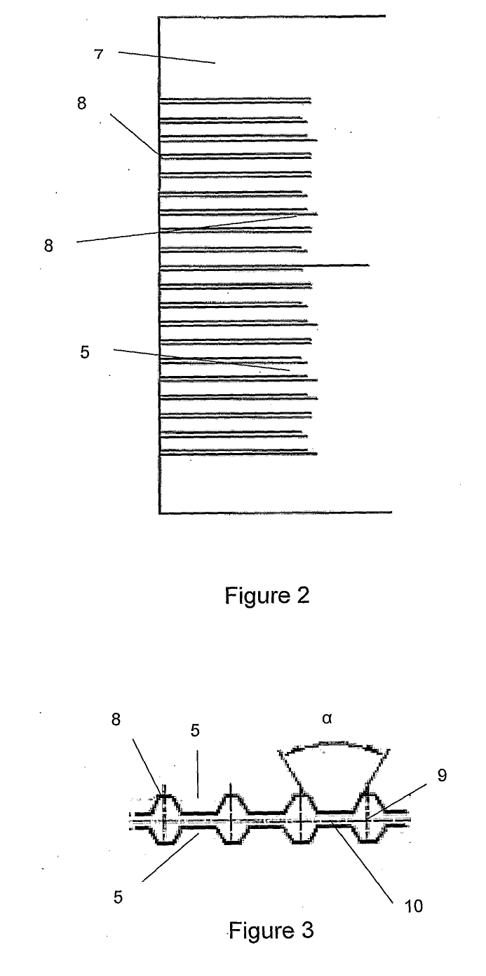

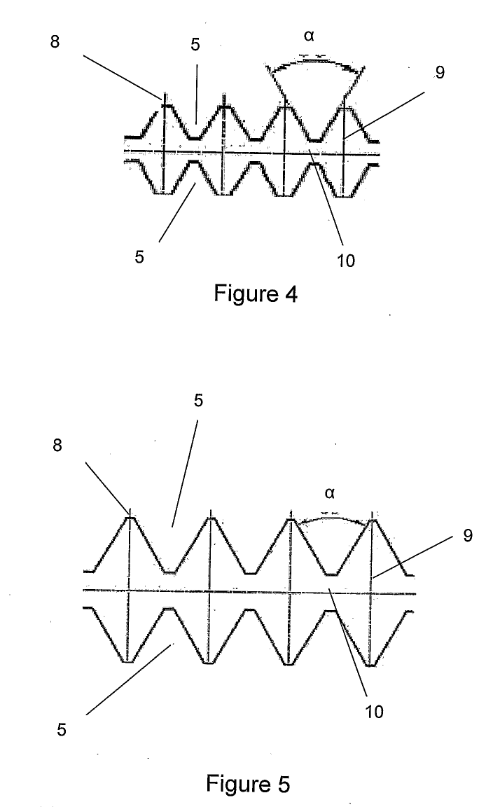

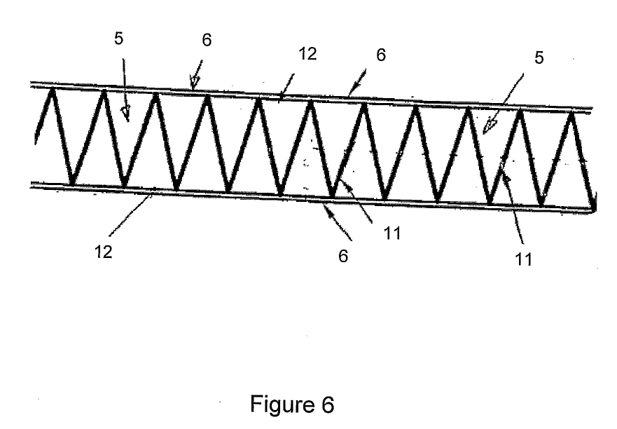

FIG. 1 is showing perspective view of spacer 1, the spacer is a extruded spacer having support members 2, which support members are provided with perforations 3. According this alternative embodiment inserted elements 4 are longitudinal walls forming flow space 5 between the support members 2 and the longitudinal walls. Membranes 6 are attached on both sides of spacer 1. FIG. 2 is showing an over view of an extruded sheet 7. In this overview are the flow channels 5 parallel to each other and support units 8 are separating one channel 5 from the other. FIGS. 3, 4, and 5 are showing cross views of extruded sheets 7. The flow channels 5 may either be wide or deep depending on the angle α. The angle α being within the range form about 45° to about 75° according to one alternative of the invention. The angle α being within the range form about 50° to about 70° according to another alternative of the invention. The angle α being within the range form about 55° to about 65° according to yet another alternative of the invention. The angle α being larger than about 30° according to one alternative of the invention. The angle α being within the about 60° yet another alternative of the invention. The distance 9 being within the range from about 0.1 mm to about 4.0 mm according to one alternative of the invention. The distance 9 being within the range from about 0.2 mm to about 3.0 mm according to another alternative of the invention. The distance 9 being within the range from about 0.3 mm to about 2.0 mm according to yet another alternative of the invention. The distance 10, which distance being between two peaks, being within the range from about 0.1 mm to about 3.0 mm according to one alternative of the invention. The distance 10, being within the range from about 0.2 mm to about 2.0 mm according to one alternative of the invention. The distance 10 being within the range from about 0.3 mm to about 1.5 mm according to another alternative of the invention. The distance 10 being within the range from about 0.2 mm to about 2.0 mm according to one alternative of the invention. The distance 10 being about 1.0 mm according to one alternative of the invention. Support units 8 are flat and the length of the flat top being larger than 0.03 mm according to one alternative. The length being lager than 0.05 mm according to another alternative. The length being about 0.1 mm according to another alternative. The thickness between two valleys or flow channel being from about 0.05 mm according to one alternative. The thickness between two valleys or flow channel being to about 0.7 mm according to another alternative. The thickness between two valleys or flow channel being within the range from about 0.07 mm to about 0.7 mm according to another alternative. The thickness between two valleys or flow channel being about 0.1 mm according to another alternative. The thickness between two valleys or flow channel being about 0.5 mm according to another alternative. The extruded sheets shown in FIGS. 3, 4, and 5 are spacers for use both as permeate spacers and as concentrate spacers. The permeate spacers being extruded sheets having smaller distance between the peaks and wider valleys or flow channels 5 and the concentrate spacers being the extruded sheets having larger distance between the peaks and more narrow valleys or flow channels 5. FIG. 3 is showing a permeate spacer according to the invention, and FIGS. 4 and 5 are showing concentrate spacers.

FIG. 6 is showing a cross view of one alternative membrane system, wherein pleated sheet 11 is spacing apart support members 12 forming flow space in form of parallel flow channels 5. On top of support members 12 are membranes 6 attached.

In the following an investigation is carried out to compare the permeate spacer of the invention to a conventional spiral wound spacer. The purpose of the Example is to illustrate the performance of the permeate spacer, and is not intended to limit the scope of invention.

### EXAMPLE 1

### Comparison

In this example a conventional spiral wound spacer element attached to a permeate collecting device was compared to a permeate spacer according to FIG. 1 attached to a permeate collection device. Both the spiral wound spacer element and the spacer were provided with membranes on each side. The hydrostatic pressure was 1.2 m and the measured flux for the conventional spiral wound spacer was 16 dm³/m²×h and the flux with the spacer according to one embodiment of the invention was 100 dm³/m²×h showing that the spacer of the invention giving a ratio of 6.25 to the conventional spacer. The conclusion of the results are that even at low flux the importance of the free flow on the permeate side and at higher flux level the ratio increase.

What is claimed in:

1-23. (canceled)

24. A spacer for membrane modules comprising; at least one inserted element and support members selected from at least one member of the group consisting of support surface units, solid surface material having perforations, porous surface materials, composite surface materials having perforations or pores or combinations thereof, sandwich surface materials having perforations or pores, or combinations thereof, the support members being spaced apart by the at least one inserted element and forming flow channels between the support members and the inserted element for guiding permeates to the at least one permeate collection device, and the at least one permeate collection device being in substantially perpendicular contact with the flow channels, for guiding concentrate through the flow channel out of the membrane module.

25. The spacer according to claim 24, wherein the inserted elements are formed from at least one of longitudinal walls, corrugated sheets, pleated sheets, casted sheets, moulded sheets, extruded sheets, sheets having ducts or valleys, sheets having cut or flat peaks, and single distance aids.

26. The spacer according to claim 25, wherein the support members are support units of an inserted element, the inserted element being an extruded sheet with longitudinal grooves forming flow channels for draining the membrane in a pre-determined flow direction from specific areas without mixing.

27. The spacer according to claim 24, wherein the flow channels between the support members and the inserted elements are substantially parallel to each other.

28. The spacer according to claim 24, wherein the substantially parallel flow channels of the spacer used for permeate are in substantially perpendicular contact with one permeate collection tube.

29. The spacer according to claim 24, wherein the support members are formed from out of solid material having perforations and porous material.

30. The spacer according to claim 24, wherein the perforations are defined by at least one of holes, slots, and slits.

31. The spacer according to claim 24, wherein the permeate spacer is made of material(s) selected from at least one of the materials of the group consisting of metal, plastic, composite, paper, cellulose, porous material, polymeric.

32. The spacer according to claim 31, wherein the material is selected from at least one of the materials of the group consisting of polyolefin elastomers, ethylene vinyl acetate copolymers, ethylene vinyl acetate terpolymers, styrene-ethylene/butylenes-styrene block copolymers, polyurethanes, polybuthylene, polybuthylene copolymers, polyisoprene, polyisopren copolymers, acrylate, silicones, natural rubber, polyisobutylene, butylrubber, polypropylene, polypropylene copolymers, polyethylene, polyethylene copolymers, polycarbonate, fluoropolymers, polystyrene, acrylonitrile-butadien-styrene copolymers, nylons, polyvinylchloride, and copolymers and blends thereof.

33. The spacer according to claim 24, wherein the support members are spaced apart within a distance of at least 0.1 mm.

34. The spacer according to claim 24, wherein the support members are spaced apart within a distance within the range of from about 0.1 mm to about 2.0 mm.

35. A membrane module comprising a permeate collection device, membrane films and at least one spacer, wherein the membrane films are attached on both sides of the at least one spacer.

36. A membrane module according to claim 35, wherein the at least one spacer comprises at least one permeate spacer and at least one concentrate spacer, and the membrane films are attached on both sides of the at least one permeate spacer.

37. A membrane module according to claim 35, wherein the module also comprises one or more permeate transfer leaves, and one or more membrane leaves, which one or more permeate transfer leaves, and one or more membrane leaves together with the at least one permeate spacer, the at least one concentrate spacer, being wound around the permeate collection device, which permeate collection device being a permeate collection tube, which permeate collection tube comprises at least one tubular unit, which unit has spaced substantially along the unit's length a plurality of permeate transfer means, and one or more external grooves forming flow channels connecting the permeate transfer means, and at least a part of the inner side of each tubular unit having polygonal cross-section.

38. The membrane module according to claim 37, wherein the permeate collection tub has two grooves helically connecting the plurality of permeate transfer means, which permeate transfer means being holes spaced apart in two rows along the length of the tube and on diagonally opposite sides of the tube, and the tow grooves circling helically around the tube and along the length of the tube.

39. The membrane module according to claim 38, wherein the permeate collection tube being one of moulded and injection moulded.

40. The membrane module according to claim 35, wherein the membrane module also is utilised in microfiltration, ultrafiltration, nanofiltration, or reverse osmosis.

41. The membrane module according to claim 35, wherein the flow channels of the spacers, the permeate spacers and the concentrate spacers, being parallel to each other in the membrane module or being perpendicular to each other in the membrane module.

42. The membrane module according to claim 41, wherein the flow channels of the spacers, the permeate spacers and the concentrate spacers, being perpendicular to each other in the membrane module.

43. The membrane module according to claim 35, wherein the membrane module is a spiral wound membrane.

44. A membrane module according to claim 35 for use in treatment of wastewater, seawater, surface water or well water.

45. A membrane module according to claim 35 for use in sterile filtration, clarification, or concentration of high molecule weights.

46. A membrane module according to claim 35 for use in the processing of vine, beer, fruit juice concentration, sterile filtration of milk.
